(19) United States
(12) Patent Application Publication
(10) Pub. No.: US 2005/0086084 A1
(43) Pub. Date: Apr. 21, 2005

(54) Method of administrating insurance coverage for multi tasks building projects

(76) Inventor: Greg Dillard, Bethlehem, GA (US)

Correspondence Address: Carl M. Davis II;Baker, Donelson, Bearman & Caldwell, Suite 900, Five Concourse Parkway, Atlanta, GA, 30328, US

(21) Appl. No.: 10/307,000

(22) Filed: Nov. 27, 2002

Related U.S. Application Data
(60) Provisional application No. 60/363,521, filed on Mar. 13, 2002.

(51) Int. Cl. G06F 17/60

(52) U.S. Cl. 705/4

(57) ABSTRACT

A method of administrating a builders risk insurance program with a computer system wherein builders may initiate coverage for individual building projects as they are begun from remote terminals by entering data on each project into the computer system which then computes and displays premium information based on previously master policy entered data. A method by which a builder initiates builders risk insurance is disclosed. A method by which a provider of builders risk insurance enables builders to initiate builders risk coverage for specific projects.

### REFERENCE TO RELATED APPLICATION

This application claims the priority benefit of provisional patent application Ser. No.: 60/363,521 filed Mar. 13, 2002, incorporated herein by reference.

### TECHNICAL FIELD

This invention relates to the administration of builder's risk property insurance, and more particularly to the automated administration of insurance for multi tasks building projects.

### BACKGROUND OF THE INVENTION

Professional builders are usually not self insured but rather purchase insurance to cover risks of loss or damage to buildings as they are being constructed. They also usually borrow the funds needed for construction from lending institutions which also require risk protection. This mandates that the builder or general contractor usually secure an insurance policy from an insurance company for each building project, notify the insurance company of the amount of coverage required as each project progresses and becomes more valuable, thus requiring increasing levels of financial protection, pay the premiums due periodically, and maintain records. Due to the ever changing dynamics of such insurance programs, their administration is relatively burdensome on all parties involved in comparison to more static insurance programs such as personal property insurance and life insurance. Indeed, some builders may have 50 or more buildings on different lots at various stages of development at any one time within a single subdivision.

It thus is seen that a need exists for an automated method of administrating insurance coverage for multi tasks building projects. It is to the provision of such that the present invention is primarily directed.

### SUMMARY OF THE INVENTION

The present invention is a computer automated method of administrating an insurance program for multi tasks building projects. The method is useful for example in providing and maintaining insurance for housing developers as they build and sell individual houses on individual lots of residential subdivisions.

In a preferred form of the invention master insurance policy data is entered into a central computer of a computer system that includes building parameters such as geographic date, building size and lender identification from which date premiums may be computed for specific building projects of a designated builder. The builder enters specific data on a specific building project from a remote terminal of the computer system. The central computer then computes the premium for that project which is displayed at the remote terminal. The builder himself may then initiate insurance coverage on that project by entering acceptance from the remote terminal.

### BRIEF DESCRIPTION OF THE DRAWING

The drawing is a block diagram showing insurance coverage administered in accordance with the invention for several builders each of whom has a number of building projects in development that are at risk of loss or damage.

### DETAILED DESCRIPTION

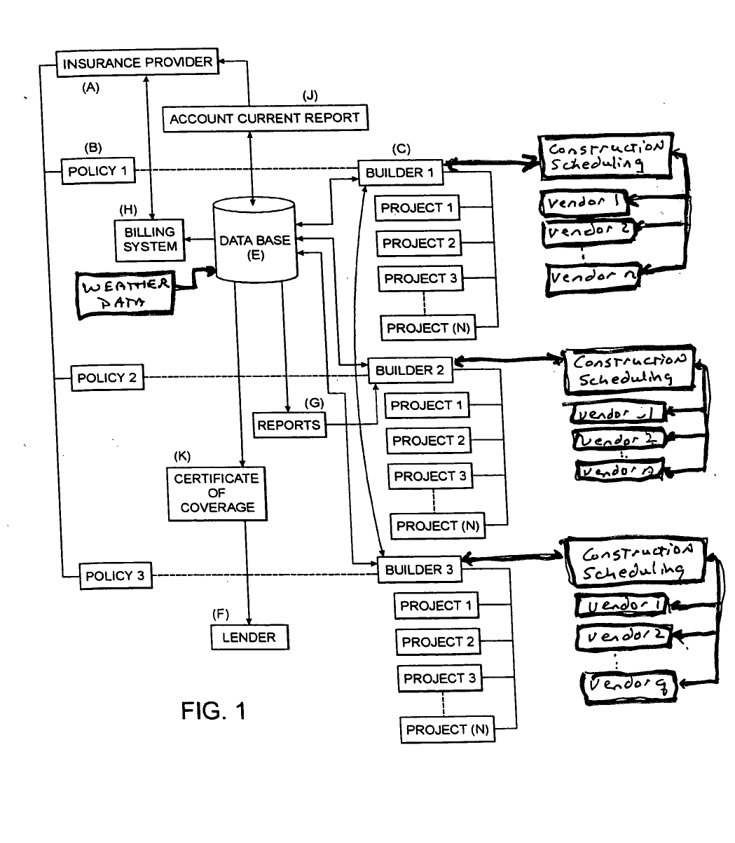

FIG. 1 generally illustrates use being made of the new administration method by three builders. Each builder is seen to have a number of building construction projects in progress. In this example each project of each builder is seen to be financed by a common lender and to be insured by a common insurance provider. However, the projects may be financed by distinct lenders. A master or blanket policy is issued to each of the builders in favor of the lender. The central computer is programmed to generate certificates of insurance coverages to the lender as new projects are begun and financed. It also periodically generates reports to the builders' computer terminals via the internet.

More specifically, the insurance provider issues a master policy to each builder in preparation for the provision of property insurance for projects as they come on line. Terms of the master or blanket policy are entered into the computer database. These terms include identification of the builders, the insurance providers and lenders, the policy numbers, and the effective dates. Premium rates, deductibles and limits on coverages are entered and a billing account number generated.

With this new administration method the builders themselves have direct access to the automatic system using their own computer terminal as via the internet, a wireless terminal device or telephone, or other computer communication device, to initiate coverage for each of their projects as they are started. To enable this upon purchase of their blanket policies they are issued user codes and passwords for this direct access.

To initiate coverage for a project a builder is prompted to enter the project location, the type of construction, such as brick or frame, the replacement cost of the building less land and land improvement costs, the size of the building, the number of stories and the name and address of the lender. Upon entry the computer is programmed to compute premiums in accordance with the current terms of the blanket or master policy. In this regard territorial multipliers may add surcharges for hazardous locations such as along coastlines or geological fault lines, indexable as by zip code. The computed premium is displayed on the builder's terminals who may then activate coverage or choose instead to store the displayed information for possible later use.

Once project coverage is initiated under a blanket policy the computer generates a certificate of insurance coverage that is sent to the lender and to the builder. The timing for periodic reports is then initiated.

Preferably a credit card billing system is used for payment of the insurance premiums. Upon initiation of coverage the credit card insurer is issued access codes and notified of project identifications and premium charges along with the insured's billing account number. The billing service credits premiums less its own fee to the central computer and issues periodic statements that list all the insured projects and their premiums to the builder for payment. Premiums are periodically paid to the insurer.

The administration method may also include hazardous weather tracking information and automatically suspend acceptance of new projects in the affected area during hazardous conditions. Again, zip codes may be used for locations in this regard. Once a project is completed and the building sold, the insurer is notified and that project is deleted from coverage under the blanket policy.

It is to be appreciated that the project data entered by the builder to initiate builders risk insurance coverage according to the present invention is used in an alternate embodiment that further includes a construction scheduling system by which the builder schedules construction activities for the project and tracks construction progress and includes access to the construction scheduling system by vendors to coordinate and schedule delivery of goods and labor services for the project while preventing access by the vendors to the insurance-related data.

It thus is seen that a method is now provided whereby builders may secure insurance coverages for their projects on line on an automated basis with advance knowledge of the cost involved. The computerized method administers the insurance program automatically and continuously makes adjustments for changing coverages, premiums and reports as projects are added and deleted by the builders. Although the administration method has been described in its preferred form, it should be understood that modifications, additions and deletions may be made thereto without departure from the spirit and scope of the invention as set forth in the following claims.

1. A method of administrating a builders risk insurance program with a computer system that includes a central computer that is accessible from a remote terminal and which comprises the steps of:
(a) entering master insurance policy data that includes a plurality of building parameters into the central computer database from which data premiums may be computed for specific building projects of a designated builder,
(b) the designated builder entering data on a specific building project into the computer system from the remote terminal,
(c) computing the insurance premium for the project and displaying the premium at the remote terminal; and
(d) the builder initiating insurance coverage for the building project by acceptance entry from the remote terminal.

2. The method of claim 1 wherein step (a) the insurer enters geographic data and building size data.

3. The method of claim 2 wherein data on the weather predicated for the geographic area of the specific building project is entered into the computer system and updated and wherein step (d) the initiation of insurance coverage the specific building project suspended while the weather data includes dangerous conditions data for that geographic area.

4. The method of claim 1 wherein step (a) the insurer enters data regarding the identification of a lender that provides funding for construction of the building project.

5. The method of claim 4 further comprising the step of the lender generating periodic statements that list all current specific project loan amounts and loan payments due to be paid by the builder.

6. The method of claim 1 further comprising the step of (e) generating a printed certificate of insurance coverage for the specific building project.

7. The method of claim 1 further comprising the step of (e) the builder entering in the computer system from the remote terminal data regarding sale of the specific building project from the remote terminal and insurance coverage for the project being terminated.

8. A method for a construction builder having a plurality of construction projects to initiate and monitor builders risk insurance with a central computer system accessible from a remote terminal, comprising the steps of:
(a) a construction builder obtaining a blanket coverage builders risk insurance policy from an insurance provider and reflected in a central computer database of insurance policy terms from which insurance premiums may be computed for specific building projects of the builder;
(b) the builder entering data on a specific building project into the computer database from a remote terminal;
(c) computing the insurance premium for the specific building project; and
(d) the builder initiating insurance coverage for the specific building project by acceptance entry from the remote terminal.

9. The method of claim 8 wherein step (b) the builder enters geographic data and building size data for the specific project.

10. The method of claim 9 wherein data on the weather predicated for the geographic area of the specific building project is entered into the computer system and updated and wherein step (d) the initiation of insurance coverage for the specific building project is suspended while the weather data includes dangerous conditions data for that geographic area.

11. The method of claim 8 wherein step (a) further comprises the insurer entering data regarding the identification of a lender that provides funding for construction of the building project.

12. The method of claim 11 further comprising the step of the lender generating periodic statements that list all current specific project loan amounts and loan payments due to be paid by the builder.

13. The method of claim 8 further comprising the step of (e) generating a printed certificate of insurance coverage for the specific building project.

14. The method of claim 8 further comprising the step of (e) the builder entering in the computer system from the remote terminal data regarding sale of the specific building project from the remote terminal and insurance coverage for the project being terminated.

15. The method of claim 8, further comprising the step of (e) generating a charge to a credit provider by which funds are transferred to the insurer by the credit provider for the premium for the specific project and an invoice is sent by the credit provider to the builder for payment of said transferred funds.

16. The method of claim 8 further comprising the step of generating periodic statements that list all current specific projects included in the blanket coverage builders risk insurance policy.

17. A method for a provider of builders risk insurance to insure a plurality of building construction projects by a plurality of construction builders with the builders risk insurance for a particular project initiated by the construction builder accessing a central computer system from a remote terminal, comprising the steps of:
(a) providing a blanket coverage builders risk insurance policy for at least one construction builder as reflected in a central computer database of insurance policy terms from which insurance premiums may be computed for specific building projects of the builder;
(b) the builder entering data on a specific building project into the computer database from a remote terminal;
(c) computing the insurance premium for the specific building project; and
(d) the builder initiating insurance coverage for the specific building project by acceptance entry from the remote terminal.

18. The method of claim 17 wherein step (b) the builder enters geographic data and building size data for the specific project.

19. The method of claim 18 wherein data on the weather predicated for the geographic area of the specific building project is entered into the computer system and updated and wherein step (d) the initiation of insurance coverage for the specific building project is suspended while the weather data includes dangerous conditions data for that geographic area.

20. The method of claim 17 wherein step (a) further comprises the insurer entering data regarding the identification of a lender that provides funding for construction of the building project.

21. The method of claim 20 further comprising the step of the lender generating periodic statements that list all current specific project loan amounts and loan payments due to be paid by the builder.

22. The method of claim 17 further comprising the step of (e) generating a printed certificate of insurance coverage for the specific building project.

23. The method of claim 17 further comprising the step of (e) the builder entering in the computer system from the remote terminal data regarding sale of the specific building project from the remote terminal and insurance coverage for the project being terminated.

24. The method of claim 17, further comprising the step of (e) generating a charge to a credit provider by which funds are transferred to the insurance provider by the credit provider for the premium for the specific project and an invoice is sent by the credit provider to the builder for payment of said transferred funds.

25. The method of claim 17 further comprising the step of generating periodic statements that list specific projects included in the blanket coverage builders risk insurance policy for the builder.
